(19) United States
(12) Patent Application Publication
(10) Pub. No.: US 2005/0170168 A1
(43) Pub. Date: Aug. 4, 2005

(54) Sheet made of high molecular material and method for making same

(75) Inventors: Ching-Tang Wang, Taipei (TW); Wu-Tsang Tsai, Kaohsiung (TW); Lung-Chuan Wang, Jenwu Shiang (TW); Chung-Chih Feng, Sanmin Chiu (TW); Chun-Wei Wu, Niaosong Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: San Fang Chemical Industry Co., LTD., Jenwu Shiang (TW)

(21) Appl. No.: 11/026,869

(22) Filed: Dec. 30, 2004

(30) Foreign Application Priority Data
Dec. 31, 2003 (TW) 092137684

(51) Int. Cl. B32B 3/26; B32B 27/00; B32B 27/40

(52) U.S. Cl. 428/322.2; 428/423.1

(57) ABSTRACT

A method for making a macromolecular laminate is disclosed. Firstly, polyurethane resin with solid content higher than 50% is mixed with additives in order to form polyurethane resin compound that is liquid at the normal temperature. Then, the polyurethane resin compound is coated on releasing paper and dried. Then, the releasing paper is removed in order to make a laminate.

### BACKGROUND OF INVENTION

1. Field of Invention

The present invention relates to a macromolecular laminate and a method for making the same.

2. Related Prior Art

In a conventional method for making a macromolecular laminate, granular, thin or powdery solid macromolecular compound (such as thermal plastic polyurethane (“TPU”), polypropylene, polyethylene and polyvinyl chloride) is mixed with additives, heated and molten. The mixture is injected, co-extruded or blow-molded to form a macromolecular laminate.

However, in the conventional method, because the solid macromolecular compound is used to make the macromolecular laminate, operative variables must be adjusted in order to solve problems related to melting, rheology and temperature. In a conventional method and equipment, there is a rather high minimum requirement on material. Furthermore, the complicated equipment must be cleaned up in order to make a different laminate. Therefore, it is material-intensive, time-consuming and expensive. In the conventional method for making the laminate, the hardness of the macromolecular resin such as TPU is about 85 to 98 (scale: Shore Hardness, A; test method: ASTM D-2240), and the 100% modulus is about 60 to 130 kg/cm² (test method: ASTM D-412). The laminate is hard, not soft. According to the conventional method and material, the laminate is made with only a few patterns and colors. In the conventional method for using the solid macromolecular compound to make the macromolecular laminate, lubricant or plasticizer is used generally. The lubricant or plasticizer is however released from the surface of the laminate so that the surface of the laminate loses its brightness.

### SUMMARY OF INVENTION

The primary objective of the present invention is to provide a method for making a macromolecular laminate that can obviate or at least alleviate the problems encountered in prior art through making a laminate that can exhibit a lot of patterns and colors and flexibility.

To achieve the above-mentioned objective and other objectives, the present invention provides a method for making a macromolecular laminate. Firstly, a first type of polyurethane resin compound is coated on releasing paper in order to make a main layer. The first type of polyurethane resin compound is made from polyurethane resin with solid content higher than 50% and is liquid at the normal temperature. Then, the releasing paper is removed from the main layer, thus leaving a macromolecular laminate.

To make the macromolecular laminate with colors, before the first polyurethane resin compound is coated, a second type of polyurethane resin compound is coated on the releasing paper in order to form an auxiliary layer. Then, the first type of polyurethane resin compound is coated on the auxiliary layer. The second type of polyurethane resin compound is made of polyurethane resin with solid content lower than 50%. Thus, the auxiliary layer is thinner than the main layer. The auxiliary layer is made with a different color than the main layer so that the laminate exhibits a bright color. In addition, the releasing paper may include a pattern in order to leave a pattern on the laminate.

The present invention is characterized in using high solid-content polyurethane resin compound that is liquid at the normal temperature (the first type of polyurethane resin compound) to form the thick macromolecular laminate. Because no solid macromolecular compound is used, there is no need to control complicated variables in order to solve problems related to the melting, rheology and temperature of such solid macromolecular compound. In addition, a blender and a coating device can be used instead of a conventional bulky and complicated machine. Hence, the laminate can be made at a small or large number based on the need. Furthermore, only the blender and the coating device have to be cleaned between two different batches of laminates. Hence, the material, time and cost are reduced significantly. The laminate is flexible since it is made of polyurethane resin in the present invention. In addition, since no lubricant is used, the brightness lasts for long.

Other advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1a is a cross-sectional view of a laminate at a step of a method according to the present invention, and shows an auxiliary layer formed on releasing paper.

FIG. 1b is a cross-sectional view of the laminate at another step of the method according to the present invention, and shows a main layer formed on the auxiliary layer.

FIG. 1c is a cross-sectional view of the laminate at another step of the method according to the present invention, and shows the releasing paper removed in order to form a macromolecular laminate.

### DETAILED DESCRIPTION OF EMBODIMENTS

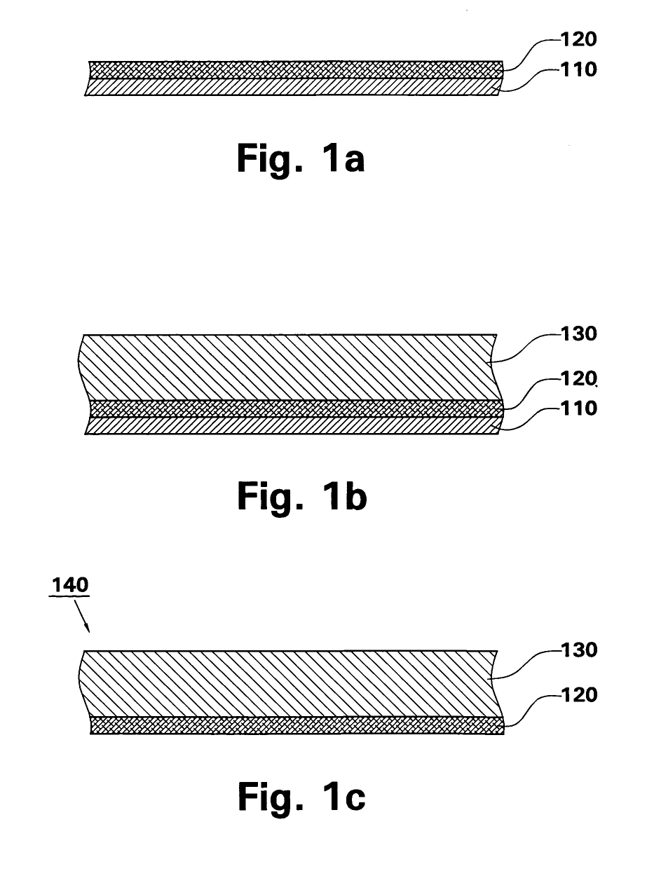

Referring to FIGS. 1a through 1c, a method for making a macromolecular laminate will be described. Firstly, referring to FIG. 1a, polyurethane resin is coated on releasing paper 110 and dried in order to form an auxiliary layer 120. Then, referring to FIG. 1b, high solid-content polyurethane resin is coated on the auxiliary layer 120 and dried and cured in order to form a main layer 130. Finally, referring to FIG. 1c, the releasing paper 110 is removed in order to form a macromolecular laminate 140 with thickness of 0.01 to 3 mm.

A feature of the present invention is using the liquid high solid-content polyurethane resin to form the rather thick main layer 130 (the thickness of the main layer 130 may reach 3 mm) in order to provide the thick and elastic laminate 140.

The solid content of the polyurethane resin for making the main layer 130 is higher than 50% and, more preferably, 80% to 100% and, more preferably, 99%. More specifically, the high solid-content polyurethane resin contains a relative small amount of organic dissolvent and does not release a large amount of organic dissolvent when forming the main layer 130. The thickness of the high solid-content polyurethane resin only changes a little before and after it is dried so that the polyurethane resin can easily form the thick main layer 130 that is thick and flexible. Furthermore, for many purposes, one or more additives, such as filler, auxiliary, crosslinker and colorant may be added to the high solid-content polyurethane resin. Preferably, the filler should be less than 50% of the high solid-content polyurethane resin. The filler should be less than 20% of the high solid-content polyurethane resin. The crosslinker should be less than 20% of the high solid-content polyurethane resin. The colorant should be less than 15% of the high solid-content polyurethane resin. In the embodiment of the present invention, preferably, the high solid-content polyurethane resin is baked at about 100 to 170 degrees Celsius. Moreover, foaming agent may be added to the high solid-content polyurethane resin in order to form a porous main layer 130.

Another feature of the present invention is using the low solid-content polyurethane resin to form the auxiliary layer 120 on the main layer 130. The solid content of the polyurethane resin for making the auxiliary layer 120 is lower than 50% and, more preferably, 10% to 30%. For being made of the low solid-content polyurethane resin, the auxiliary layer 120 is thinner than the main layer 130. The auxiliary layer 120 may exhibit a different color than the main layer 130 so that the laminate 140 exhibits a desired color. Based on design requirements, the auxiliary layer 120 may be made to include a plurality of layers with a same color or different colors. Furthermore, the releasing paper 110 may include patterns in order to leave patterns on the laminate 140 after it is removed.

The present invention is characterized in using the high solid-content polyurethane resin compound to form the thick macromolecular laminate 140. Because no solid macromolecular compound is used, there is no need to control complicated variables in order to solve problems related to the melting, rheology and temperature of such solid macromolecular compound. In addition, a blender and a coating device can be used instead of a conventional bulky and complicated machine. Hence, the laminate 140 can be made at a small or large number based on the need. Furthermore, only the blender and the coating device have to be cleaned between two different batches of laminates 140. Hence, the material, time and cost are reduced significantly. The laminate 140 is flexible since it is made of polyurethane resin in the present invention. In addition, because no lubricant is used, the brightness lasts for long. The macromolecular laminate of the present invention may be used as a logo or a surface layer adhered to ordinary leather.

The following embodiments are given in order to describe, not to limit, the present invention in detail:

### EXAMPLE 1

100 PHR of polyurethane resin with solid content of 99%, 20 PHR of filler, 3 PHR of modifier, 5 PHR of crosslinker and 3 PHR of colorant are mixed to form high solid-content polyurethane resin coating. PHR (“parts per hundred parts of resin by mass”) means an amount of units of mass of additive added to 100 units of mass of the polyurethane resin.

After coated on patterned releasing paper, the polyurethane resin is dried at 165 degrees Celsius. Finally, the releasing paper is removed, thus leaving a thick, flexible and patterned laminate. The thickness of the laminate is 0.5 mm.

### EXAMPLE 2

100 PHR of polyurethane resin with solid content of 99%, 20 PHR of filler, 3 PHR of modifier, 5 PHR of crosslinker and 3 PHR of are mixed to form high solid-content polyurethane resin coating. PHR (“parts per hundred parts of resin by mass”) means an amount of units of mass of additive added to 100 units of mass of the polyurethane resin.

Low solid-content polyurethane resin compound made of polyurethane resin with solid content lower than 20% is coated on releasing paper. The low solid-content polyurethane resin compound is dried at 120 degrees Celsius in order to form an auxiliary layer. The high solid-content polyurethane resin is coated on releasing paper and dried at 165 degrees Celsius. Then, the releasing paper is removed, thus leaving a brightly colorful, thick and flexible laminate. The thickness of the laminate is 0.5 mm.

### COMPARATIVE EXAMPLE

Solid TPU resin is extruded to make a macromolecular laminate of a thickness of 0.5 mm.

The softness of the laminate of the comparative example is about 1.9, whereas the softness of the example 1 and example 2 is about 4.8. The softness test is conducted by a leather softness tester whose model number is BLC ST300 and manufactured by RWD BRAMLEY, a British company. The tested leather is softer as the value is higher. Hence, the laminate made according to the present invention is much softer than the conventional laminate.

The present invention has been described via detailed illustration of some embodiments. Those skilled in the art can derive variations from the embodiments without departing from the scope of the present invention. Therefore, the embodiments shall not limit the scope of the present invention defined in the claims.

1. A method for making a macromolecular laminate comprising the steps of:
mixing polyurethane resin with solid content higher than 50% with additives in order to form a first type of polyurethane resin compound that is liquid at the normal temperature;
coating the first type of polyurethane resin compound on releasing paper;
drying the first type of polyurethane resin compound in order to form a main layer; and
removing the releasing paper from the main layer in order to make the macromolecular laminate.

2. The method for making a macromolecular laminate according to claim 1 wherein the first type of polyurethane resin compound is made of polyurethane resin with solid content of 80% to 100%.

3. The method for making a macromolecular laminate according to claim 1 wherein the additives comprise a filler less than 50% of the polyurethane resin.

4. The method for making a macromolecular laminate according to claim 1 wherein the additives comprise an auxiliary less than 20% of the polyurethane resin.

5. The method for making a macromolecular laminate according to claim 1 wherein the additives comprise a crosslinker less than 20% of the polyurethane resin.

6. The method for making a macromolecular laminate according to claim 1 wherein the additives comprise a colorant less than 15% of the polyurethane resin.

7. The method for making a macromolecular laminate according to claim 1 wherein the step of drying is conducted at 110 to 170 degrees Celsius.

8. The method for making a macromolecular laminate according to claim 1 further comprising the step of coating a second type of polyurethane resin compound on the releasing paper, the step of drying the second type of polyurethane resin compound in order to make an auxiliary layer and the step of coating the first type of polyurethane resin compound on the auxiliary layer.

9. The method for making a macromolecular laminate according to claim 8 wherein the second type of polyurethane resin compound is made of polyurethane resin with solid content lower than 50%.

10. The method for making a macromolecular laminate according to claim 8 wherein the auxiliary layer is made with a different color than the main layer.

11. The method for making a macromolecular laminate according to claim 8 wherein the auxiliary layer is thinner than the main layer.

12. The method for making a macromolecular laminate according to claim 1 wherein the thickness of the macromolecular laminate is 0.01 to 3 mm.

13. The method for making a macromolecular laminate according to claim 1 wherein the releasing includes a pattern in order to leave a pattern on the macromolecular laminate.

14. A macromolecular laminate comprising a main layer made of a first type of polyurethane resin compound that is liquid at the normal temperature, the first type of polyurethane resin compound is made through mixing polyurethane resin with solid content higher than 50% with additives.

15. The macromolecular laminate according to claim 14 comprising an auxiliary layer on the main layer, wherein the auxiliary layer is made of a second type of polyurethane resin compound.

16. The macromolecular laminate according to claim 15 wherein second type of polyurethane resin compound is made of polyurethane resin with solid content lower than 50%.

17. The macromolecular laminate according to claim 15 wherein the auxiliary layer is made with a different color than the main layer.

18. The macromolecular laminate according to claim 15 wherein the auxiliary layer is thinner than the main layer.

19. The macromolecular laminate according to claim 14 wherein the macromolecular laminate comprises a pattern.

20. The macromolecular laminate according to claim 17 wherein the auxiliary layer is a laminate of layers with different colors.
